(19) United States
(12) Patent Application Publication
(10) Pub. No.: US 2014/0376607 A1
(43) Pub. Date: Dec. 25, 2014

(54) PERCEPTUAL LOSSLESS COMPRESSION OF IMAGE DATA TO REDUCE MEMORY BANDWIDTH AND STORAGE

(71) Applicants: Sreenath Kurupati, Sunnyvale, CA (US); Tanuja Rao, Campbell, CA (US); Arup Gupta, Sunnyvale, CA (US)

(72) Inventors: Sreenath Kurupati, Sunnyvale, CA (US); Tanuja Rao, Campbell, CA (US); Arup Gupta, Sunnyvale, CA (US)

(21) Appl. No.: 13/995,589

(22) PCT Filed: Dec. 21, 2011
(86) PCT No.: PCT/US2011/066590

§ 371 Date: Jul. 30, 2014

(51) Int. Cl. H04N 19/182; H04N 19/593; H04N 19/503

(52) U.S. Cl. CPC H04N 19/00303; H04N 19/00575; H04N 19/00763
USPC 375/240.02

(57) ABSTRACT

Methods and systems may include a compression module having logic to receive a pixel difference signal associated with an image, and conduct a compression of the pixel difference signal based on a value of the pixel difference signal. The logic can also generate a modified pixel difference signal based on the compression, wherein the compression may enable the image to be stored to dynamic random access memory (DRAM) in a compressed state.

### BACKGROUND

In video and image processing, applications can consume significant amounts of memory bandwidth (and associated storage) due to the size of video frames, as well as high resolutions, bit precisions and frame rates. Furthermore, these factors may continue to increase as computing platforms evolve.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of an image encoder according to an embodiment;

FIG. 2 is a flowchart of an example of a method of compressing a pixel difference signal according to an embodiment;

FIG. 3A is an illustration of an example of an uncompressed image;

FIG. 3B is an illustration of an example of a compressed image according to an embodiment;

FIG. 4 is a block diagram of an example of a computing platform according to an embodiment;

FIG. 5 is a block diagram of an example of a system having a navigation controller according to an embodiment; and

FIG. 6 is a block diagram of an example of a system having a small form factor according to an embodiment.

### DETAILED DESCRIPTION

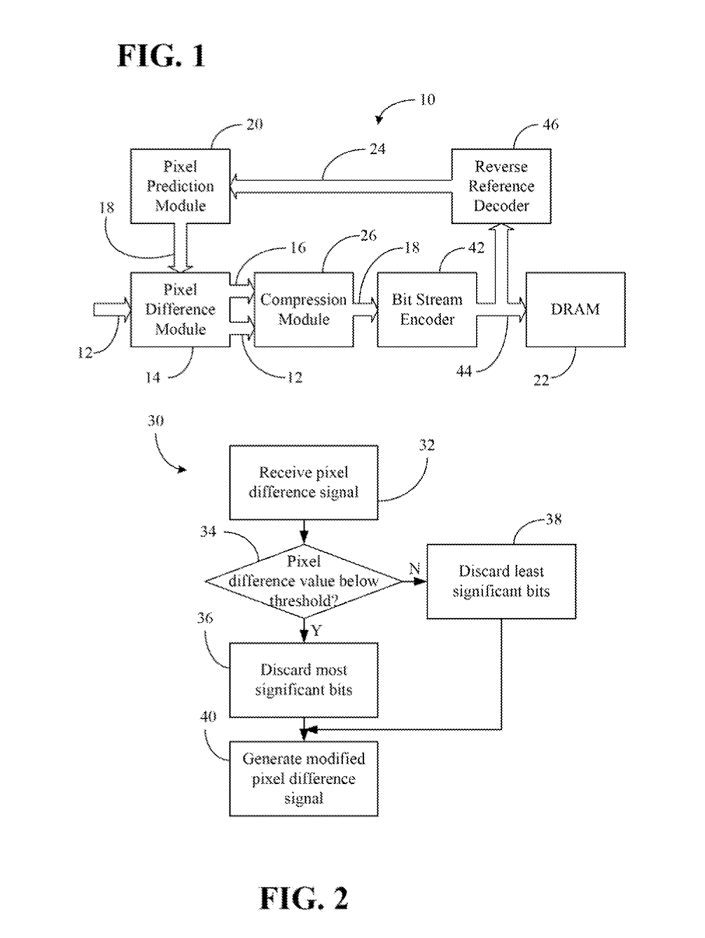

Turning now to FIG. 1, an image encoder 10 is shown in which an input pixel signal 12 is processed. The input pixel signal 12 may be associated with image and/or video content, wherein the input pixel signal 12 might contain RGB (red/green/blue) raw data, YCbCr (lumina, chroma blue-difference, chroma red-difference) raw data, and so forth. In the illustrated example, a pixel difference module 14 generates a pixel difference signal 16 based on the input pixel signal 12 and a pixel prediction signal 18. As will be discussed in greater detail, the pixel difference signal 16 can identify the difference between each pixel in the input pixel signal 12 and a prediction of the pixel in question. Moreover, the pixel difference signal 16 may be compressed in a perceptually lossless fashion that reduces memory bandwidth and storage requirements.

In particular, a pixel prediction module 20 may use a reference signal 24 to predict pixel values for the pixels in an image, wherein the predictions can take into consideration related pixels. For example, the pixel prediction module 20 might evaluate a combination of spatially and temporally adjacent pixels to predict the value of a pixel under consideration. Thus, a prediction of a current pixel could be assigned the value of a horizontally adjacent pixel in the same row (e.g., pred[j,i]=pxl[j,i−1]), the value of either a horizontally adjacent or a vertically adjacent pixel based on the results of an edge detection process, the value of the same pixel in a in previous frame (e.g., temporally adjacent pixel), and so forth. Other related pixel-based predictors may also be used.

Thus, the pixel difference module 14 can compare each pixel to its prediction and output the pixel difference signal 16 based on the comparison, wherein the illustrated pixel difference signal 16 identifies the difference between a current pixel and a prediction of the current pixel. The image encoder 10 may also include a compression module 26 having logic to receive the pixel difference signal 16 and the input pixel value 12, conduct a compression of the pixel difference signal 16 based on the value of the pixel difference signal 16, and generate a modified pixel difference signal 18 based on the compression.

FIG. 2 shows one approach to conducting a compression in a method 30. The method 30 may be implemented in a compression module such as the compression module 26 (FIG. 1) as a set of executable logic instructions stored in a machine- or computer-readable storage medium such as random access memory (RAM), read only memory (ROM), programmable ROM (PROM), flash memory, firmware, etc., in configurable logic such as programmable logic arrays (PLAs), field programmable gate arrays (FPGAs), complex programmable logic devices (CPLDs), in fixed-functionality hardware using circuit technology such as application specific integrated circuit (ASIC), complementary metal oxide semiconductor (CMOS) or transistor-transistor logic (TTL) technology, or any combination thereof. For example, computer program code to carry out operations shown in the method 30 may be written in any combination of one or more programming languages, including an object oriented programming language such as C++ or the like and conventional procedural programming languages, such as the “C” programming language or similar programming languages. Moreover, various aspects of the method 30 could be implemented as embedded logic of a graphics processor using any of the aforementioned circuit technologies.

Illustrated processing block 32 provides for receiving a pixel difference signal, wherein block 34 may determine whether the value of the pixel difference signal is below a certain threshold. For example, if the pixel difference signal contains an 8-bit difference value (e.g., red difference, green difference, blue difference) ranging from 0-255, a threshold of sixteen might be used. If the value of the pixel difference signal is below the threshold, one or more most significant bits (MSBs) of the pixel difference signal can be discarded at block 36. Thus, in the example of an 8-bit difference value, the four MSBs (e.g., bits [7:4]) might be discarded in block 36. In this regard, no information is lost because the higher bits in the pixel difference signal would be zero if the value of the pixel difference signal is below the threshold.

If, on the other hand, it is determined at block 34 that the pixel difference value is not below the threshold, illustrated block 38 discards one or more least significant bits (LSBs) in the in pixel difference signal. Thus, in the example of an 8-bit difference value, the four LSBs (e.g., bits [3:0]) could be discarded at block 38. Of particular note is that if the pixel difference value is relatively high, the visual difference between the current pixel and its related pixels may also be relatively high. For example, a high pixel difference value may be indicative of an edge (e.g., abrupt color and/or intensity transition) in the image at the pixel location, wherein the abrupt transition can far outweigh any minor differences in color/intensity from a visual standpoint. Thus for example, an edge transition from a shade of red (R_orig) to a shade of blue (B_orig) could be coded as an edge transition from a slightly different shade of red (R_new) to a slightly different shade blue (R_blue) (e.g., by discarding LSBs) without causing a perceptual loss of content/quality in the image. Accordingly, although the discarded bits may contain some information, the lost information is not likely to be perceivable to the human eye since the transition is fairly large (i.e., from red to blue). Simply put, when surrounding pixels do not have the same intensity level of the pixel in question, the human eye cannot accurately estimate precise intensity and no perceptual loss is encountered when discarding LSBs.

Illustrated block 40 provides for generating a modified pixel difference signal based on the compression. In particular, the modified pixel difference signal will always be compressed in the example shown, which provides significant memory bandwidth and storage advantages over conventional lossless compression techniques that do not guarantee compression. Moreover, the illustrated approach can achieve such guaranteed compression without encountering perceptual losses.

Other implementations may also be used depending upon the circumstances. For example, the pseudo code below might be deployed for scenarios in which one or more flag bits are used to embed the compression configuration into the modified pixel difference signal and 50% compression is a criterion.

```
Encoding 8-bit to 4-bit example
delta[8:01] = input_val[7:0] - pred_val[7:0]; // the extra bit is for
negative delta
if (abs(delta[8:0]) >20) {
  enc_val[3] = 1; // quantization flag
  enc_val[2:0] = input_val[7:5]; //quantization
}
else {
    enc_val[3] = 0 ; // not quantized
    if (delta[8:0] < 0) enc_val[2] = 1; // sign bit
else enc_val[2] = 0;
abs_delta [7:0] = abs(delta[8:0]);
if (abs_delta[7:0] ==0)  enc_val[1:0] = 0; // 0
else if (abs_delta[7:0] <=2)  enc_val[1:0] = 1; // 1,2
else if (abs_delta[7:0] <=7)  enc_val[1:0] = 2;
else if (abs_delta[7:0] <20) enc_val[1:0] = 3;
}
  Decoding 4-bit to 8-bit example
if (enc_val[3] == 1 { // value was quantized during encoding
    Decoded_val = enc_val [2:0]*32 + 16;
}
else {
  if (enc_val[1:0]==0) dec_delta = 0;
  else if (enc_val[1:0]==1) dec_delta = 1;
  else if (enc_val[1:0]==2) dec_delta = 4;
  else if (enc_val[1:0]==3) dec_delta = 11;
  if (enc_val[2]==1) dec_ delta = 0-dec_delta; // negative delta
decoded_val = pred_val + dec_delta;
}
  Encoding 10-bit to 5-bit example
delta[10:0] = input_val[9:0] - pred_val[9:0]; // the extra bit is for
negative delta
if (abs(delta[10:0]) > 64) {
  enc_val[4] = 1; // quantization flag
  enc_val[3:0] = input_val[9:6] //quantization
}
else {
  enc_val[4] = 0 ; // not quantized
  if (delta[10:0] < 0) enc_val[3]= 1; // sign bit
  else enc_val[3]= 0;
  abs_delta[9:0] = abs(delta[10:0]);
  if (abs_delta [9:0]==0  enc_val[2:0] = 0;
  else if (abs_delta [9:0]==1)  enc_val[1:0] = 1;
  else if (abs_delta [9:0]==2)  enc_val[1:0] = 2;
  else if (abs_delta [9:0]==3)  enc_val[1:0] = 3;
  else if (abs_delta [9:0]==7)  enc_val[1:0] = 4;
  else if (abs_delta [9:0] <= 19)  enc_val[1:0] = 5;
  else if (abs_delta [9:0] <= 39)  enc_val[1:0] = 6;
  else if (abs_delta [9:0] <= 63)  enc_val[1:0] = 7;
}
  Decoding 5-bit to 10-bit example
if (enc_val[4] == 1) { //value was quantized during encoding
  decoded_val = enc_val[3:0]*64 + 32;
}
else {
  if (enc_val[2:0]==0) dec_delta = 0;
  else if (enc_val[2:0]==1) dec_delta = 1;
  else if (enc_val[2:0]==2) dec_delta = 2;
  else if (enc_val[2:0]==3) dec_delta = 3;
  else if (enc_val[2:0]==4) dec_delta = 4;
  else if (enc_val[2:0]==5) dec_delta = 12;
  else if (enc_val[2:0]==6) dec_delta = 28;
  else if (enc_val[2:0]==7) dec_delta = 52;
  if (enc_val[3]==1) dec_delta = 0-dec_delta; // negative delta
  decoded_val = pred_val + dec_delta;
}
```

In addition, adaptivity based on previous pixel encoding may be implemented. For example, the pseudo code below might be deployed for the 8-bit to 4-bit encoding example.

```
if (prev_enc_pxl[3] ==1) {
  // quantize without a flag
  Enc_val[3:0] = input_val[7:4];
}
else {
// Else clause code below is identical to initial 8b to 4b example.
delta[8:0] = input_val[7:0] - pred_val[7:0]; // the extra bit is for
negative delta
if (abs(delta[8:0]) > 20) {
  enc_val[3] = 1; // quantization flag
  enc_val[2:0] = input_val[7:5]; //quantization
}
else {
  enc_val[3] = 0 ; // not quantized
  if (delta[8:0] < 0) enc_val[2] = 1;// sign bit
  else enc_val[2]= 0;
  abs_delta[7:0] = abs(delta[8:0]);
  if (abs_delta[7:0] ==0 enc_val[1:0] = 0; // 0
  else if (abs_delta[7:0] <=2) enc_val[1:0] = 1; // 1,2
  else if (abs_delta[7:0] <=7) enc_val[1:0] = 2;
  else if (abs_delta[7:0] <20) enc_val{1:0] = 3;
}
```

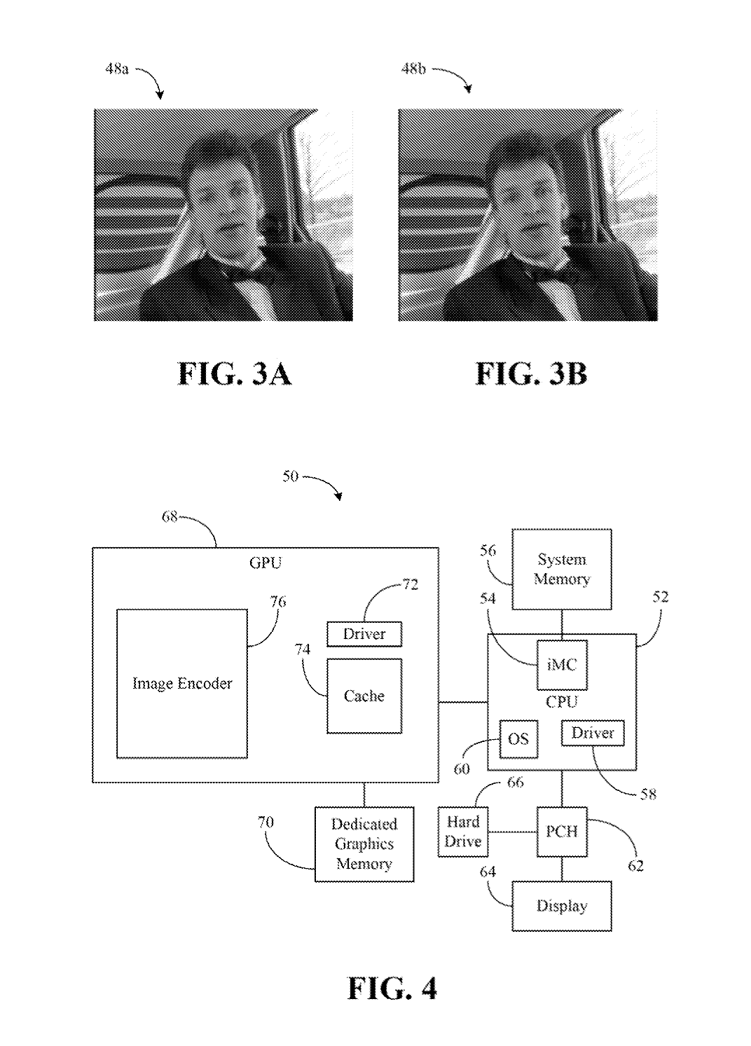

Returning now to FIG. 1, the image encoder 10 may also include a bit stream encoder 42 that generates an encoded bit stream 44 based on the modified pixel difference signal 18. The encoding method can be any standard video encoding method. A reverse reference decoder 46 may be used to generate the reference signal 24 based on the encoded bit stream 44, wherein the reverse reference decoder may reverse the encoding process so that the pixel prediction module 20 can predict pixels with the same reference as the receiving decoder (not shown). In addition, transfer logic may be used to store the embedded bit stream 44 to a volatile memory such as dynamic RAM (DRAM) 22. FIG. 3A shows an original image 48a and FIG. 3B shows a compressed image 48b, wherein the compressed image 48b exhibits no perceptual loss.

FIG. 4 shows a platform 50, wherein the platform 50 may be a mobile platform such as a laptop, mobile Internet device (MID), personal digital assistant (PDA), media player, imaging device, etc., any smart device such as a smart phone, smart tablet and so forth, or any combination thereof. The platform 50 may also be a fixed platform such as a personal computer (PC), server, workstation, smart TV, etc. The illustrated platform 50 includes a central processing unit (CPU. e.g., main processor) 52 with an integrated memory controller (iMC) 54 that provides access to system memory 56, which could include, for example, double data rate (DDR) synchronous DRAM (SDRAM, e.g., DDR3 SDRAM JEDEC Standard JESD79-3C, April 2008) modules. The modules of the system memory 56 may be incorporated, for example, into a single inline memory module (SIMM), dual inline memory module (DIMM), small outline DIMM (SODIMM), and so on. The CPU 52 may also have one or more drivers 58 and/or processor cores (not shown), where each core may be fully functional with instruction fetch units, instruction decoders, level one (L1) cache, execution units, and so on. The CPU 52 could alternatively communicate with an off-chip variation of the iMC 54, also known as a Northbridge, via a front side bus or a point-to-point fabric that interconnects each of the components in platform 50. The CPU 52 may also execute an operating system (OS) 60 such as a Microsoft Windows, Linux, or Mac (Macintosh) OS.

The illustrated CPU 52 communicates with a platform controller hub (PCH) 62, also known as a Southbridge, via a hub bus. The iMC 54/CPU 52 and the PCH 62 are sometimes referred to as a chipset. The CPU 52 may also be operatively connected to a network (not shown) via a network port (not shown) through the PCH 62. A display 64 (e.g., touch screen, liquid crystal display/LCD, light emitting diode/LED display) could also communicate with the PCH 62 in order to allow a user to view images and/or video from the platform 50. The illustrated PCH 62 is also coupled to storage, which may include a hard drive 66, ROM, optical disk, flash memory (not shown), etc.

The illustrated platform 50 also includes a dedicated graphics processing unit (GPU) 68 coupled to a dedicated graphics memory 70. The dedicated graphics memory 70 could include, for example, GDDR (graphics DDR) or DDR SDRAM modules, or any other memory technology suitable for supporting graphics rendering. The GPU 68 and graphics memory 70 might be installed on a graphics/video card, wherein the GPU 68 could communicate with the CPU 52 via a graphics bus such as a PCI Express Graphics (PEG, e.g., Peripheral Components Interconnect/PCI Express x16 Graphics 150W-ATX Specification 1.0, PCI Special Interest Group) bus, or Accelerated Graphics Port (e.g., AGP V3.0 Interface Specification, September 2002) bus. The graphics card may be integrated onto the system motherboard, into the main CPU 52 die, configured as a discrete card on the motherboard, etc. The GPU 68 may also execute one or more drivers 72, and may include an internal cache 74 to store instructions and other data.

The illustrated GPU 68 includes an image encoder 76 such as the image encoder 10 (FIG. 1), already discussed. Thus, the image encoder 76 may be configured to compress a pixel difference signal associated with an image based on the value of the pixel difference signal, generate an encoded bit stream based on the compressed pixel difference signal, and store the encoded bit stream to a volatile memory such as the graphics memory 70 or system memory 56, in conjunction with the presentation of the image to a user via the display 64. In particular, an entire channel of DDR memory usage could be eliminated through the guaranteed compression techniques of the image encoder 76, while the compressed image data can remain perceptually lossless.

Embodiments may therefore include a compression module having logic to receive a pixel difference signal associated with an image. The logic may also conduct a compression of the pixel difference signal based on a value of the pixel difference signal, and generate a modified pixel difference signal based on the compression.

Embodiments can also include a computer readable storage medium having a set of instructions which, if executed by a processor, cause a computer to receive a pixel difference signal associated with an image. In addition, the instructions may cause a computer to conduct a compression of the pixel difference signal based on a value of the pixel difference signal, and generate a modified pixel difference signal based on the compression.

In addition, embodiments may include a computer implemented method in which a pixel difference signal associated with an image is received, wherein the pixel difference signal identifies a difference between a current pixel and a related pixel. A compression of the pixel difference signal can be conducted based on a value of the pixel difference signal, and a modified pixel difference signal may be generated based on the compression. The method may also provide for generating an encoded bit stream based on the modified pixel difference signal, and storing the encoded bit stream to a DRAM. In one example, the DRAM is at least one of a system memory and a dedicated graphics memory.

Other embodiments can include a system having a pixel difference module to generate a pixel difference signal based on an input pixel signal associated with an image, and a pixel prediction signal. The system may also have a compression module with compression logic to receive the pixel difference signal, conduct a compression of the pixel difference signal based on a value of the pixel difference signal, and generate a modified pixel difference signal based on the compression. In addition, the system may have a bit stream encoder to generate an encoded bit stream based on the modified pixel difference signal, a reverse reference decoder to generate a reference signal based on the encoded bit stream, and a pixel prediction module to generate the pixel prediction signal based on the reference signal.

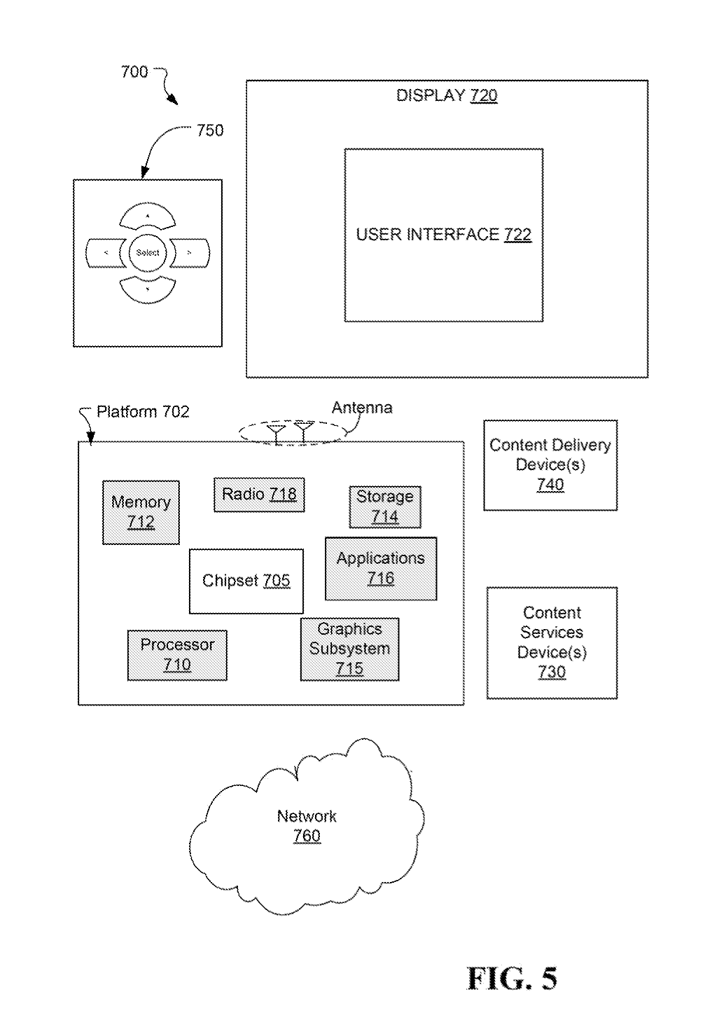

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, in touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface. DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may in include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

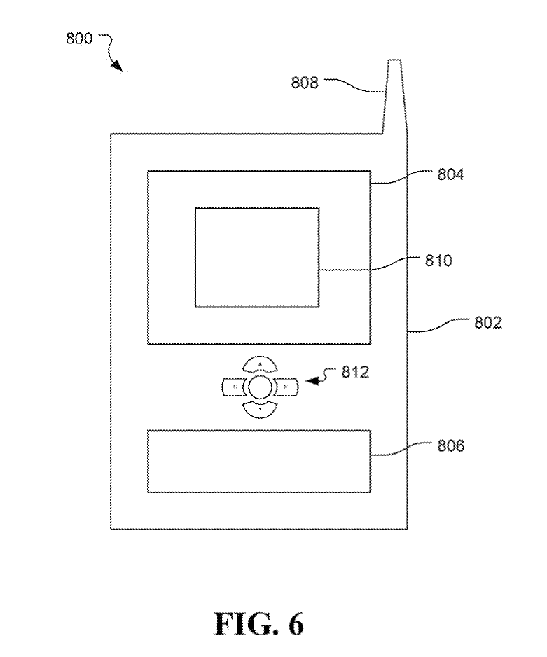

As described above, system 700 may be embodied in varying physical styles or form factors. FIG. 6 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, in combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as no desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The in description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not in be so limited since other modifications will become apparent to the skilled practitioner upon a study of the drawings, specification, and following claims.

We claim:

1. A computer implemented method comprising:
receiving a pixel difference signal associated with an image, wherein the pixel difference signal identifies a difference between a current pixel and a prediction of the current pixel;
conducting a compression of the pixel difference signal based on a value of the pixel difference signal;
generating a modified pixel difference signal based on the compression;
generate an encoded bit stream based on the modified pixel difference signal; and
storing the encoded bit stream to a dynamic random access memory, wherein the dynamic random access memory is at least one of a system memory and a dedicated graphics memory.

2. The method of claim 1, wherein conducting the compression of the pixel difference signal includes discarding one or more most significant bits of the pixel difference signal in response to determining that the value of the pixel difference signal is below a threshold.

3. The method of claim 1, wherein conducting the compression of the pixel difference signal includes discarding one or more least significant bits of the pixel difference signal in response to determining that the value of the pixel difference signal is above a threshold.

4. The method of claim 1, wherein the prediction of the current pixel is based on a related pixel that is at least one of spatially adjacent and temporally adjacent to the current pixel.

5. A system comprising:
a pixel difference module to generate a pixel difference signal based on an input pixel signal associated with an image, and a pixel prediction signal;
a compression module including compression logic to,
receive the pixel difference signal,
conduct a compression of the pixel difference signal based on a value of the pixel difference signal, and
generate a modified pixel difference signal based on the compression;
a bit stream encoder to generate an encoded bit stream based on the modified pixel difference signal;
a reverse reference decoder to generate a reference signal based on the encoded bit stream; and
a pixel prediction module to generate the pixel prediction signal based on the reference signal.

6. The system of claim 5, further including:
a volatile memory; and
transfer logic to store the embedded bit stream to the volatile memory.

7. The system of claim 6, wherein the volatile memory is a dynamic random access memory.

8. The system of claim 7, wherein the dynamic random access memory is at least one of system memory and dedicated graphics memory.

9. The system of claim 5, wherein the compression logic is to discard one or more most significant bits of the pixel difference signal in response to determining that the value of the pixel difference signal is below a threshold.

10. The system of claim 5, wherein the compression logic is to discard one or more least significant bits of the pixel difference signal in response to determining that the value of the pixel difference signal is above a threshold.

11. The system of claim 5, wherein the pixel difference signal is to identify a difference between a current pixel and a prediction of the current pixel, and wherein the pixel prediction signal is to indicate the prediction of the current pixel.

12. The system of claim 11, wherein the pixel prediction signal is to be generated based on a related pixel that is at least one of spatially adjacent and temporally adjacent to the current pixel.

13. A compression module comprising:
logic to,
receive a pixel difference signal associated with an image,
conduct a compression of the pixel difference signal based on a value of the pixel difference signal, and
generate a modified pixel difference signal based on the compression.

14. The compression module of claim 13, wherein the logic is to,
generate an encoded bit stream based on the modified pixel difference signal, and
store the encoded bit stream to a volatile memory.

15. The compression module of claim 14, wherein the encoded bit stream is to be stored to a dynamic random access memory.

16. The compression module of claim 15, wherein the encoded bit stream is to be stored to at least one of a system memory and a dedicated graphics memory.

17. The compression module of claim 13, wherein the logic is to discard one or more most significant bits of the pixel difference signal in response to determining that the value of the pixel difference signal is below a threshold.

18. The compression module of claim 13, wherein the logic is to discard one or more least significant bits of the pixel difference signal in response to determining that the value of the pixel difference signal is above a threshold.

19. The compression module of claim 13, wherein the pixel difference signal is to identify a difference between a current pixel and a prediction of the current pixel.

20. The compression module of claim 19, wherein the prediction of the current pixel is to be based on a related pixel that is at least one of spatially adjacent and temporally adjacent to the current pixel.

21. A computer readable storage medium comprising a set of instructions which, if executed by a processor, cause a computer to:
receive a pixel difference signal associated with an image;
conduct a compression of the pixel difference signal based on a value of the pixel difference signal; and
generate a modified pixel difference signal based on the compression.

22. The medium of claim 21, wherein the instructions, if executed, cause a computer to:
generate an encoded bit stream based on the modified pixel difference signal; and
store the encoded bit stream to a volatile memory.

23. The medium of claim 22, wherein the encoded bit stream is to be stored to a dynamic random access memory.

24. The medium of claim 23, wherein the encoded bit stream is to be stored to at least one of a system memory and a dedicated graphics memory.

25. The medium of claim 21, wherein the instructions, if executed, cause a computer to discard one or more most significant bits of the pixel difference signal in response to determining that the value of the pixel difference signal is below a threshold.

26. The medium of claim 21, wherein the instructions, if executed, cause a computer to discard one or more least significant bits of the pixel difference signal in response to determining that the value of the pixel difference signal is above a threshold.

27. The medium of claim 21, wherein the pixel difference signal is to identify a difference between a current pixel and a prediction of the current pixel.

28. The medium of claim 27, wherein the prediction of the current pixel is to be based on a related pixel that is at least one of spatially adjacent and temporally adjacent to the current pixel.
